(19) United States
(12) Patent Application Publication
(10) Pub. No.: US 2010/0027919 A1
(43) Pub. Date: Feb. 4, 2010

(54) METHOD OF PRODUCING A PACKAGING POUCH AND RESULTING PACKAGING POUCH

(76) Inventor: Jerome Faytre, Hoerdt (FR)

Correspondence Address: EGBERT LAW OFFICES, 412 MAIN STREET, 7TH FLOOR, HOUSTON, TX, 77002, US

(21) Appl. No.: 12/443,818

(22) PCT Filed: Oct. 3, 2007
(86) PCT No.: PCT/FR2007/052073

§ 371 Date: Mar. 31, 2009

(30) Foreign Application Priority Data
Oct. 3, 2006 (FR) 0654070

(51) Int. Cl. B31B 19/90; B31B 19/14; B31B 19/26; B31B 19/62; B65D 30/22

(52) U.S. Cl. 383/38; 493/186; 493/210; 493/224; 493/231; 493/264

(57) ABSTRACT

Method of producing a packaging pouch includes the steps of forming a tube on a rotary machine by longitudinally rolling at least one band of flexible material, dividing the tube into lengths and forming the bottom of each pouch to form a compartment. The step of forming the bottom includes paying out and driving and feeding into the forming tube at least one other band, simultaneously dividing the tube into lengths and the other band into segments, causing the front part of the tube to become staggered relative to the front part of the other band or the lengths to become staggered relative to the segments, and finally forming the bottom of each pouch by folding each length transversely.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The object of this invention is a method for producing a packaging pouch, and the resulting packaging pouch.

The invention relates, essentially but not restrictively, to the field of the food industry, and more specifically the so called fast-food business, the packaging pouch obtained based on the manufacturing method according to the invention being capable of being used for packing food products such as sandwiches or other similar products.

2. Description of Related Art Including Information Disclosed Under 37 CFR 1.97 and 37 CFR 1.98.

One of the problems set forth in this application, and which this invention tries to solve, has been the object of numerous proposals without finding a solution that is both effective, and economically and technically feasible.

When one eats a sandwich or some other similar product, it is obviously necessary to wipe one's mouth and/or fingers, which is done by means of a napkin generally supplied with the sandwich. Said napkin is either self-service for the consumer, or distributed with the sandwich by the seller, which, in both cases, creates disadvantages.

As a matter of fact, when the napkins are available as self-service, the consumer might forget to take one, or he could take more than he needs, which brings about extra costs for the seller. Besides, he will touch other napkins that are not meant to be used by him, which can create problems of hygienic nature.

In another case, when the napkins are distributed by the seller, beside the specific gesture that should be repeated each time, said seller might, by mistake, give the buyer more napkins than he needs, also bringing about extra costs, and he can also forget to give one, with the risk of provoking the discontent of said buyer.

In order to cope with these disadvantages, packaging pouches have been provided, which incorporate a napkin, so as to have a napkin, and a single one, per package, and therefore avoid the risk of forgetting.

Some have thus provided to manually insert beforehand a napkin in each pouch, which represents extra costs in terms of labor, with, nevertheless, the disadvantage of risking soiling it with the sandwich, and thus making it hardly usable.

Others have provided, in particular in U.S. Pat. No. 4,941,756, a packaging pouch one part of which, the one including the opening, is formed of a detachable napkin. Such a package does not solve the problem with soiling the napkin.

From DE 86 30 396 is also known a packaging pouch including two compartments, one of which contains a napkin. The formation of the two compartments is obtained by adding an internal wall separating the inside of the pouch, whereas one of the compartments contains a napkin. However, the napkin remains maintained by the bottom of the pouch, and it is therefore necessary to provide perforations there in order to be able to tear it and extract it from the pouch.

From EP 858 951 is also known as a packaging pouch obtained by superposing three sheets, sealed on two or three sides according to the shape of said sheets, so as to create two pockets, designed one for containing a sandwich, and the other one a napkin. Though such a package allows coping with the abovementioned disadvantages, it still creates numerous difficulties regarding the manufacturing, and therefore considerable extra costs. Besides having to glue or seal two, three sides, and even more, the insertion of the napkin into the pocket can only be carried out after the manufacturing, eventually manually, thus increasing substantially the cost price of said package.

EP 1 203 726 provides a pouch on an external face of which is detachably attached a napkin. Said napkin is glued to the external face through a portion connected to the rest of the napkin through a perforated and therefore divisible area.

Such a pouch, though it permits to cope with the abovementioned disadvantages, has however itself some disadvantages. As a matter of fact, the napkin hangs inside the pouch, and it can thus be soiled at any time, both before and after the sale, and therefore it may not be clean when it is about to be used.

On the other hand, the portion remaining glued to the pouch is not used.

Finally, as far as manufacturing is concerned, for such a pouch the cutting, the perforation and the gluing of the napkin require specialized equipment capable of generating extra manufacturing costs.

From U.S. Pat. No. 5,590,783 is also known a sandwich package of the type formed either of a sheet folded into two and designed for pinching said sandwich, or of a type of cone more specifically including two walls made integral with each other through two adjacent edges. In this document, it is provided to manufacture this package based on a multilayer sheet including an intermediate sheet formed of a napkin that can be pulled out and used by the consumer.

The disadvantage of such a package resides in the complexity of its manufacturing, requiring specialized tools, which increases its cost price.

The aim of this invention is to provide a packaging pouch permitting to cope with these various disadvantages, but the primary aim of this invention is to provide an industrial manufacturing method permitting the continuous manufacturing of such a packaging pouch at a minimum cost, and above all by using the existing manufacturing means.

Various package manufacturing techniques are known, and one should distinguish between packages manufactured based on paper sheets that are shaped and glued, and those based on sheets of sealable materials, according to the technique referred to as “form seal”, which is described in WO 2003 07331, U.S. Pat. No. 4,009,778 and U.S. Pat. No. 5,407,278, for example.

The technique referred to as “form seal” is essentially designed to permit to manufacture pouches and to bag the product to be packaged simultaneously, and it is not adapted to the manufacture of the packaging pouches object of this invention, essentially because of the materials used.

In the field of the manufacture of packaging pouches based on paper sheets, one should also distinguish between different techniques.

Known is thus the technique using rotary machines operating continuously, in which pouches are obtained as a result of operations of shaping and gluing a paper strip, then of cutting said shaped strip for dividing the pouches, finally of an operation of forming the bottom of the bag. It should be noted that there are essentially three ways of dividing the pouches, either by preliminary weakening, by means of perforations, then tearing by traction, or weakening and, almost instantaneously, tearing, or just by cutting.

Also known is the technique using alternative machines operating by cycles, where the original paper strip is cut before shaping in the machine. Such machines permit to manufacture pouches provided with one or more external pockets created by applying and gluing one or more sheets on the one and/or the other side of the bag.

Also known, from U.S. Pat. No. 4,993,845 and GB 2 211 07 9, are pouches manufactured by superposing several sheets, and in particular a sheet permitting to constitute a pocket designed to contain an object. The technique for manufacturing pouches would not allow continuous manufacturing of the packaging pouch object of this invention.

### BRIEF SUMMARY OF THE INVENTION

Therefore, the objective of this invention is to cope with the above-mentioned various disadvantages, and its object is a method for continuously manufacturing a packaging paper pouch incorporating an extractable element, such as a napkin, implemented entirely by means of existing manufacturing tools.

The method for producing a packaging pouch according to the invention is of the type consisting in forming a tube on a rotary machine by longitudinally rolling at least one strip of flexible material which is paid out and driven, then in eventually gluing, after a sizing operation, the lateral edges of said strip, then in dividing said tube into lengths and in forming the bottom of each pouch to form a compartment, and it essentially consists in:
paying out and driving, simultaneously with the paying out and driving of the strip forming said tube, so as to cause it to advance inside the latter under formation, at least one other strip of another material or of the same material,
simultaneously dividing the tube into lengths and said other strip into segments,
causing the front portion of said tube to become staggered with respect to the front portion of said other strip, or the lengths to become staggered with respect to said segments,
and finally forming the bottom of each pouch by folding each length transversely.

The operation of shifted positioning aims at creating, in the end, a shifting of the position of the segment with respect to that of the length, thus freeing a portion of length without segment, and designed to form the bottom by transversal folding, thus allowing subsequently the free extraction of the segment.

According to a particular embodiment of the manufacturing method according to the invention, the dividing operation is carried out as follows:
weakening, simultaneously or almost simultaneously, the strip before forming the tube, as well as the other strip,
shifting the tube and the other strip so that the weakening area of said tube is staggered with respect to the weakening area of said other strip,
tearing simultaneously said tube and said strip.

It should be noted that the weakening of the two strips can be performed simultaneously on the same tool, or either simultaneously or not on two different tools, one for each strip, but conforming to a particular timing.

According to an additional feature of the manufacturing method according to the invention, the shifting is carried out by causing the tube and the other strip to adopt paths having different lengths.

According to another particular embodiment of the manufacturing method according to the invention, the dividing operation is carried out as follows:
driving the tube and the other strip at different speeds,
cutting transversely and simultaneously the tube and the other strip, or weakening and tearing simultaneously, or almost simultaneously, the tube and the other strip.

It should be noted that in this embodiment an appropriate friction between the materials permits the movement of the strip in the tube before the separation, yet ensuring after the separation the connection necessary for the other manufacturing operations.

The manufacturing method according to the invention permits, using a rotary machine of the existing type, to make packaging pouches incorporating, during manufacture, an extractable element, said pouches being able to thus consist, non-restrictively, of sandwich pouches integrating an extractable napkin.

The method according to the invention permits to make pouches of different shapes, and having various characteristics.

Thus, according to a particular embodiment of the manufacturing method according to the invention, it consists in forming, besides the main compartment, at least one secondary compartment, either by an operation of gluing of the lateral edges of the strip forming the tube, according to at least two different lines, continuous or not, and/or by at least one operation of longitudinal folding a portion of said strip, and/or by adding at least one internal or external supplementary wall, made integral with the pouch at least by pinching during the formation of the bottom and obtained as a result of the paying out of another strip, whereas simultaneously the other strip is paid out so as to be positioned inside said secondary compartment.

According to an additional feature of the particular embodiment of the manufacturing method according to the invention, the lateral edges of the strip forming the tube are made integral with the rest of the latter, by gluing, according to at least two different lines, continuous or not, so as to delimit between said two lines a region constituting the secondary compartment.

According to another additional feature of the particular embodiment of the manufacturing method according to the invention, the strip forming the tube is folded longitudinally so as to form, from one of the edges of said strip, a flap, folded inwardly or outwardly, so as to form the secondary compartment.

According to another additional feature of the particular embodiment of the manufacturing method according to the invention, one pays out, in parallel to the paying out of the strip forming the tube, another strip, the latter being made integral through its lateral edges, on the outside with one of the walls of the tube, so as to form the secondary compartment.

According to another additional feature of the particular embodiment of the manufacturing method according to the invention, one pays out, in parallel to the paying out of the strip forming the tube, and inside the tube, another strip, and it is made integral, by gluing and/or by pinching, with the bottom.

It should be noted that the manufacturing method according to the invention also permits to provide, prior to the association of the napkin and of the pouch, a station for printing said napkin, or other processing stations.

The packaging pouch obtained based on the method according to the invention can be flat, gusseted, flat-bottomed or square-bottomed, or the like.

In the case of the manufacture of a packaging pouch for packing food products such as sandwiches or similar, the other strip advantageously consists of paper of the napkin type, more specifically of cellulose wadding for example, so that, by manufacture, the napkin is integrated into the pouch.

The manufacturing method as described permits numerous variants of the product thus obtained. For example, it is possible, depending the selected embodiment, to vary the length of the napkin with respect to the depth of the secondary compartment.

Though this manufacturing method is perfectly adapted to the manufacture of packaging pouches for food products such as sandwiches or similar, it can of course be used for other applications, the napkin being, for example, replaced by a data card regarding the content of the pouch, by reinforcements, by advertising documents, by coupons, etc.

Likewise, the method according to the invention is designed for manufacturing, from a continuous material, packaging pouches containing extractable manufacturing elements obtained from a continuous material.

The advantages and the features of the method according to the invention, and of the pouches manufactured according to this method, will become more obvious from the following description referring to the attached drawing, which represents several non-restrictive embodiments thereof.

### BRIEF DESCRIPTION OF THE SEVERAL VIEWS OF THE DRAWINGS

FIG. 1 represents a schematic view reproducing steps of the manufacturing method according to the invention.

FIG. 2 represents a schematic view reproducing steps of a variant of the manufacturing method according to the invention.

FIG. 3 represents a perspective view of a packaging pouch manufactured based on the method according to the invention.

FIG. 4 represents a schematic cross-sectional view of the same packaging pouch.

FIG. 5 represents a schematic partial plan view of an element for the manufacture of the same packaging pouch.

FIGS. 6, 7, 8, 9, 10, 11 and 12 represent, each, a schematic cross-sectional view of another embodiment of the packaging pouch manufactured based on the method according to the invention.

### DETAILED DESCRIPTION OF THE INVENTION

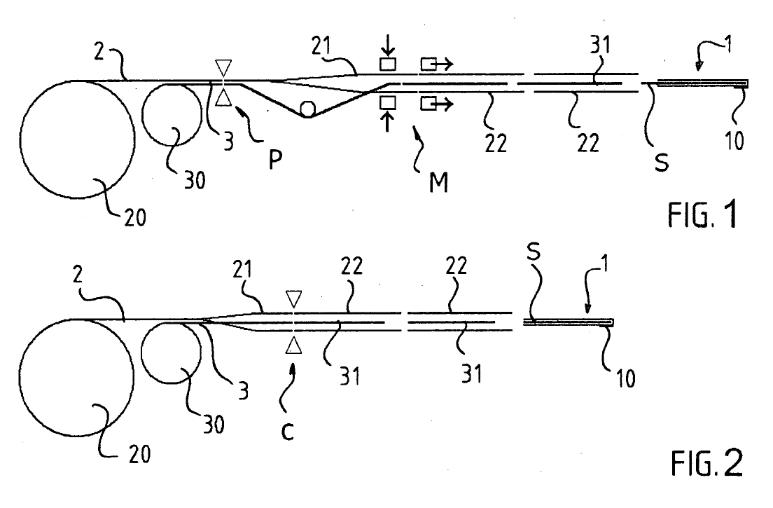

Referring to FIG. 1, one can see different steps of a method for producing a packaging pouch 1 containing an extractable napkin S.

The pouch 1 is manufactured from a strip 2 of flexible material such as paper, packaged in a roll 10, whereas the napkin S is manufactured from a strip 3 of flexible material such as wadding, packaged in a roll 30.

The forming of the pouch S is made in a classical manner, i.e. the strip 2 is shaped as a tube 21 by bringing together, overlapping and making integral its lateral edges, before forming the bottom obtained by transversal folding.

According to the method conforming to the invention, simultaneously with paying out and driving the strip 2, the strip 3 is fed inside the tube 21 under formation and, in order to obtain the pouch 1 containing its extractable napkin, the whole is subjected to a succession of operations.

One of these operations consists in cutting the tube 21 into lengths 22 and the strip 3 into segments 31. To this end, one starts by weakening transversely the strip 2 and the strip 3 through weakening means P, by perforation for example, then the strip 3 is caused to travel a longer path than that traveled by the strip 2, so as to obtain a shifting of the weakening areas, then after forming the tube around the strip 3, one proceeds, through supporting means M, to the separation in order to obtain a length 22 containing a segment 31, the positioning of the latter being shifted with respect to the length, so as to free a portion 23 thereof dedicated to forming by folding of the bottom 10 of the pouch 1, without pinching the segment 31.

It should be noted that the method, as described, can be implemented on an existing machine. In the meantime, it is possible to contemplate a variant, at the expense of modifying existing machines. It is thus possible to add to the existing machine a supplementary weakening tool, permitting to weaken the strip 2 and the strip 3 independently.

Referring now to FIG. 2, one can see a variant of the manufacturing method according to the invention, differing in the manner of carrying out the division into lengths 22 and segments 31.

Driving the tube 21 at a speed higher than that of the strip 3 and using cutting means C, one proceeds to the simultaneous cutting of the tube 21 and the strip 3, to form a length 22 and a segment 31. The difference in speed creates the shifting, which permits the formation of the bottom 10 of the pouch 1.

It should be noted that in a variant, cutting can be replaced by simultaneous or almost simultaneous operations of weakening and of tearing.

It should also be noted that, irrespective of the embodiment of the method according to the invention, the strip 3 can be subjected, before its insertion into the tube 21, to various transformations, such as a longitudinal folding, for example.

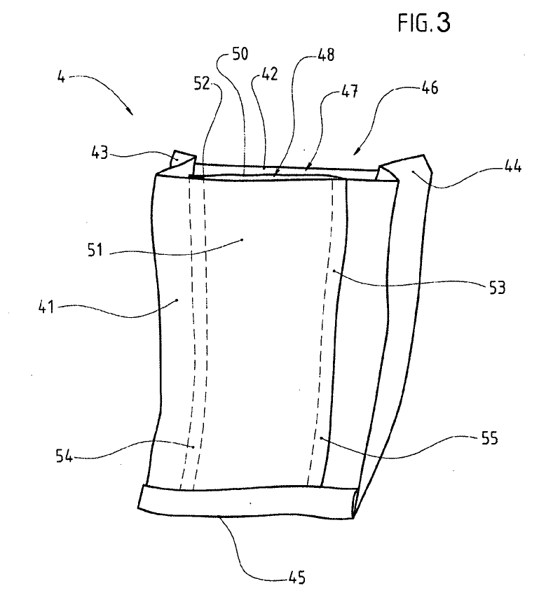

Referring now to FIG. 3, one can see a packaging pouch 4 according to the invention, also manufactured based on the method according to the invention, but showing differences with respect to the pouch 1.

The pouch 4, like the pouch 1, is non-restrictively gusseted, and is made of a strip 5 of material such as paper, shaped as a tube by bringing together and overlapping the lateral edges. This packaging pouch 4 thus includes two frontal walls 41 and 42 connected laterally through two lateral walls 43 and 44 folded so as to form gussets. It also comprises a bottom 45 obtained by the folding of the frontal walls 41 and 42, and an opening 46 permitting access to the inside of a compartment 47 delimited by the walls 41, 42, 43 and 44, and the bottom 45.

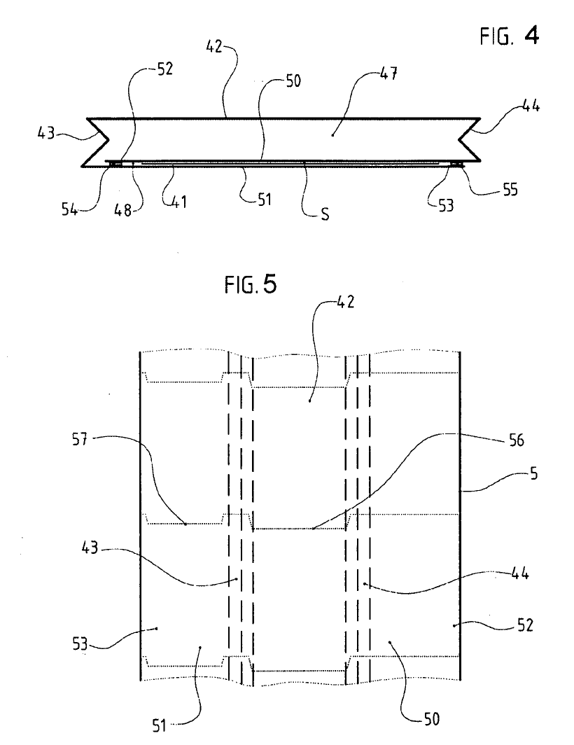

Also referring to FIG. 4, one can see that the packaging pouch 4 also comprises a compartment 48 created at the level of the frontal wall 41, and which is obtained as a result of the doubling of the latter.

As a matter of fact, as can be seen more specifically in FIG. 2, the lateral portions 50 and 51 of the strip 5 are not made integral with each other by their extreme edges, 52 and 53 respectively, so as to form the wall 41, but the latter are made integral with the rest of the strip 5 in two regions that are distant from each other, through gluing lines 54 and 55 respectively applied on the outer face of the lateral portion 50, or on the inner face of the lateral portion 51, so as to keep free, between said two lines, an unglued area constituting the compartment 48, and in which a napkin S is accommodated.

Referring now to FIG. 5, one can see a portion of a strip 5 before the formation of the tube.

Lines represent the folds that will be made during the formation, and broken lines represent the weakening, by perforations, that will permit, after tearing, the separation.

It should be noted that the pouches manufactured by means of the strip 5 represented in FIG. 5 are provided with cuts facilitating the opening and the access to compartments, more specifically a cut 56 made in the wall 42 and designed to equip the edge of the compartment 47, and a cut 57 made in the lateral portion 41 and designed to equip the edge of the compartment 48.

It should be also noted that it is possible for the pouch to comprise only one of those cuts, and eventually none.

The manufacture of the pouch 5 is identical to that of the pouch 1, except that the strip 3 is fed between the portions 50 and 51, so that the napkin S finally ends up in the compartment 58.

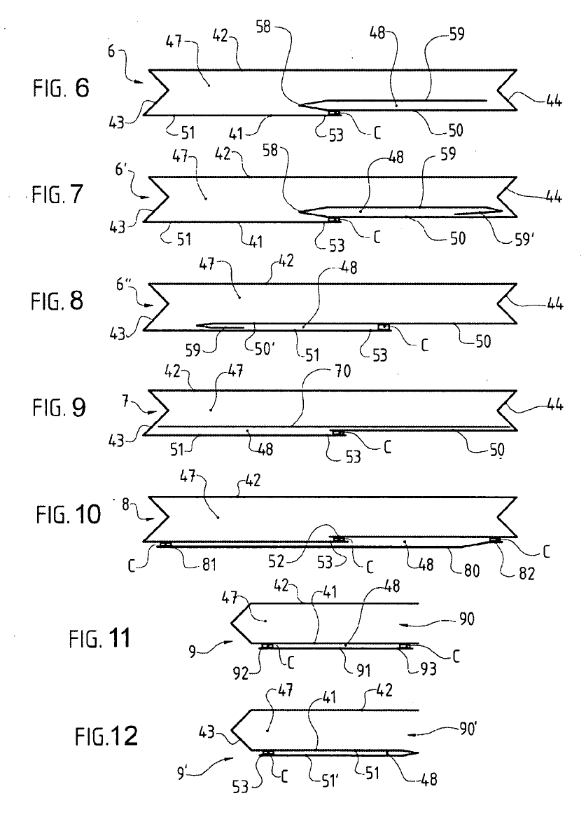

Referring now to FIGS. 6, 7, 8, 9, 10, 11 and 12, one can see, non-restrictively, different embodiments, 6, 6′, 6″, 7, 8, 9 and 9′, respectively, of the packaging pouch according to the invention. All said pouches are designed, according to the invention, to include by manufacture at least two compartments, at least one of which accommodates an extractable element incorporated by manufacture.

In FIG. 6, the pouch 6 is made of a strip 5 of flexible material, such as paper, shaped as a tube, by connection between each other of the lateral portions 50 and 51 of the strip 5, to form a compartment 47.

In this case, the extreme edge 53 of the portion 51 is made integral by gluing, through a gluing line C, not to the extreme edge 52 of the lateral portion 50, but to the latter at the level of a longitudinal fold 58 creating a flap 59 forming with the rest of the lateral portion 50 a compartment 48 by partial doubling of the frontal wall 41.

It is obvious that said compartment 48 is closed underneath during the formation of the bottom, and that it can incorporate, by manufacture, an extractable element, not shown, such as a napkin, for example.

FIG. 7 represents the pouch 6′ which consists of a variant of the pouch 6, more specifically which includes besides, at the end of the flap 59, another flap 59′ folded so as to extend between the flap 59 and the lateral portion 50, inside the compartment 48 and designed for permitting an enhanced wrapping of the extractable element, not shown.

In FIG. 8, the pouch 6″ constitutes another variant of the pouch 6, in that the extreme edge 53 of the lateral portion 51 is not made integral with the extreme edge 52 of the lateral portion 50, but with the latter, which for this reason has inside the compartment 47 an extension 50′ comprising at its end a flap 59, which is folded not inwardly with respect to the pouch, but outwardly, so as to be placed opposite the lateral portion 51.

FIG. 9 represents the pouch 7, which is also made of a strip 5 of flexible material, such as paper, shaped as a tube by connection, by gluing between each other the extreme edges 52 and 53 the lateral portions 50 and 51 of the strip 5, to form a compartment 47.

The pouch 7 also comprises an inner wall 70 extending over the entire width, or practically the entire width, of the frontal wall 41, and designed to be made integral with the rest of the pouch during the formation of the bottom thereof. The inner wall 70 is formed of a portion of another strip of flexible material, such as paper, produced simultaneously with the strip 5 during the manufacturing method.

The wall 70 creates the doubling of the frontal wall 41, and thus creates the compartment 48, which can contain an extractable element, such as for example a napkin, and which is obtained from another strip of flexible material produced simultaneously with the other strips.

FIG. 10 represents the pouch 8, which is also made of a strip 5 of flexible material, such as paper, shaped as a tube, by connection of the extreme edges 52 and 53 of the lateral portions 50 and 51 of the strip 5, to form a compartment 47.

The pouch 8 also comprises an outer wall 80, extending over the entire width, or practically the entire width, of the frontal wall 41, and designed to be made integral with the latter by gluing its extreme lateral edges 81 and 82, through gluing lines C, as well as by forming the bottom of the pouch. The outer wall 80 is formed of a portion of another strip of flexible material, such as paper, produced simultaneously with the strip 5 during the manufacturing method.

The outer wall 80 creates the doubling of the front wall 41, thus creating said compartment 48, which can contain an extractable element, such as for example a napkin, and which is obtained from another strip of flexible material produced simultaneously with the other strips.

FIG. 11 represents the pouch 9, which is in particular designed for packing sandwiches of the type including, for example and non-restrictively, a round loaf comprising a lateral opening through which ingredients are introduced. Such sandwiches are generally offered in pouches shaped approximately as a wedge.

The pouch 9, which constitutes a particular development of the pouch 8, is made of a strip 5 of flexible material, such as paper, shaped as a tube, but the latter is not closed, the frontal walls 41 and 42 being connected only by the bottom, not represented, so as to create a lateral opening 90 for the insertion of the sandwich.

The frontal wall 41 is lined externally by a wall 91 made integral by its two lateral edges 92 and 93 through gluing lines C, and preferably caught by pinching during the formation of the bottom. The doubling of the wall 41 by the wall 91 creates a compartment 48, which can contain an extractable element, such as for example a napkin, and which is obtained from another strip of flexible material produced simultaneously with the other strips.

Referring now to FIG. 12, one can see the pouch 9′, which is designed for the same use as the pouch 9, and constitutes a particular development of pouches 6, 6′ and 6″.

It is made of a strip 5 of flexible material, such as paper, shaped as an unclosed tube, the frontal walls 41 and 42 being connected only by the bottom, not shown, so as to create a lateral opening 90′ for the insertion of the sandwich.

The doubling of the frontal wall 41 so as to form the compartment 48 is obtained by the longitudinal folding of the portion 51, to form a flap 51′ and by the gluing of the extreme edge 53′ of the latter to the portion 51, in this case near the lateral wall 43.

It should be noted that in the represented embodiment, the flap 51′ is folded outwardly, but it could be contemplated to fold it inwardly.

As one can see it, the method according to the invention permits to make numerous pouches including one or more compartments, of which at least one contains, by manufacture, an extractable element such as a napkin. However, other packaging pouches can also be made, depending on the characteristics of the machines used, as for example the fact that the latter are made for closing the tube in the lower portion or in the upper portion.

By the way, certain pouches can only be produced flat, without gussets, and/or with a certain type of bottom.

On the other hand, it can be contemplated to create a window, opposite one or the other of the compartments, which is obtained in a known manner from a strip of transparent material produced simultaneously and parallel to another strip, and glued to the latter.

1. Method for producing a packaging pouch, said method comprising the steps of:
forming a tube on a rotary machine, by longitudinally rolling at least one strip of flexible material, the flexible material being paid out;
gluing, after a sizing operation, lateral edges of the strip;
dividing said tube into lengths; and
forming a bottom corresponding to each pouch by forming a compartment, wherein the step of forming said bottom comprises the steps of:
paying out and driving, simultaneously with paying out and driving the strip;
advancing said tube inside the strip under formation, at least one other strip being of flexible material;
simultaneously dividing the tube into lengths and said other strip into segments;
causing the front portion of said tube to become staggered with respect to the front portion of said other stripe or said lengths with respect to said segment; and
forming the bottom of each pouch by folding each length transversely.

2. Method for producing a packaging pouch according to claim 1, wherein the step of dividing comprises:
weakening, simultaneously, or almost simultaneously, the strip before forming the tube, as well as the other stripe;
shifting the tube and the other strip so that the weakening area of said tube is staggered with respect to the weakening area of said other strip; and
tearing simultaneously said tube and said strip.

3. Method for producing a packaging pouch according to claim 2, wherein the step of shifting is carried out by causing the tube and the other strip to adopt paths of different lengths.

4. Method for producing a packaging pouch according to claim 1, wherein the step of dividing comprises:
driving the tube and the other strip at different speeds;
cutting transversely and simultaneously the tube and the other strip; and
weakening and tearing simultaneously, or almost simultaneously, the tube and the other strip.

5. Method for producing a packaging pouch according to claim 1, further comprising the steps of:
forming at least one secondary compartment either by an operation of gluing the lateral edges of the strip and forming the tube, according to at least two different lines or by at least one operation of longitudinal folding a portion of said strip or by adding at least one supplementary inner or outer wall, being made integral with the pouch at least by pinching during the formation of the bottom and obtained as a result of the paying out of another strip, whereas simultaneously the other strip is paid out so as to be positioned inside said secondary compartment or a combination of operations.

6. Method for producing a packaging pouch according to claim 5, wherein the lateral edges of the strip are made integral with the the tube by gluing, according to at least two different lines, defining a region constituting the secondary compartment between said two lines.

7. Method for producing a packaging pouch according to claim 5, wherein the strip forming the tube is folded longitudinally so as to form, from one of the edges of said strip, a flap, folded inwardly or outwardly, so as to form the secondary compartment.

8. Method for producing a packaging pouch according to claim 5, wherein another strip is paid out, in parallel to the paying out of the strip forming the tube, the tube being made integral through its lateral edges, on the outside with one of the walls of the tube, so as to form the secondary compartment.

9. Method for producing a packaging pouch according to claim 5, wherein another strip is paid out, in parallel to the paying out of the strip forming the tube, and inside tube being made integral, by gluing or by pinching or both, with the bottom.

10. Packaging pouch comprising:
at least one compartment; and
an extractable element, being manufactured based on the manufacturing method according to claim 1.
